(19) United States
(12) Patent Application Publication
(10) Pub. No.: US 2005/0028106 A1
(43) Pub. Date: Feb. 3, 2005

(54) Graphical user interface for system status alert on videoconference terminal

(75) Inventors: Keith Britton Nelson, Austin, TX (US); Jeffry Ratcliff, Austin, TX (US); Martin Sexton, Round Rock, TX (US); Alain Nimri, Austin, TX (US)

Correspondence Address: WONG, CABELLO, LUTSCH, RUTHERFORD & BRUCCULERI,;P.C., 20333 SH 249, SUITE 600, HOUSTON, TX, 77070, US

(73) Assignee: Polycom, Inc.

(21) Appl. No.: 10/631,668

(22) Filed: Jul. 31, 2003

(51) Int. Cl. G09G 5/00; H04N 7/14

(52) U.S. Cl. 715/753; 715/756; 715/759; 715/788; 348/14.08; 348/14.03; 348/14.07; 348/14.01

(57) ABSTRACT

An “Alert” tab or button is displayed on the Graphical User Interface (GUI) of a videoconference terminal when a problem is detected in the embedded system. Selecting the tab or button—e.g., with a pointing device—causes the display to switch to a diagnostic page which provides a specific indication of the problem which has occurred. In some embodiments, the diagnostic page may provide a graphical indication of the status of various sub-systems.

### BACKGROUND

1. Field of the Invention

This invention relates to videoconferencing systems. More particularly it relates to Graphical User Interfaces used to control the operation of a video conference terminal.

2. Description of the Related Art

Videoconferencing systems are relatively complex. They typically involve a plurality of video signals, audio signals, processors, apparatus and/or software for data compression and decompression, directional microphones, speakers, video display units, feedback-prevention circuits, cameras and connections to telecommunications networks with associated interface devices.

During a videoconference, a problem in the system may require the immediate attention of the user in order for the videoconference to proceed without interruption. In the past, a system malfunction might be signaled, but the user was required to troubleshoot the problem without specific guidance from the system. The number of subsystems typically present in a videoconferencing system leaves the user with a large number of status indicators to check in order to identify a malfunctioning component. The present invention solves this problem.

### SUMMARY OF THE INVENTION

An “Alert” tab or button is displayed on the Graphical User Interface (GUI) of a videoconference terminal when a problem occurs in the embedded system. Selecting the tab or button—e.g., with a pointing device—causes the display to switch to a diagnostic page which provides a specific indication of the problem which has occurred. In some embodiments, the diagnostic page may provide a graphical indication of the status of various sub-systems.

### BRIEF DESCRIPTION OF THE DRAWINGS

FIG. 1 is a block diagram of a video conference terminal for use in a videoconferencing system.

FIG. 2 is the main page of a graphical user interface for a videoconferencing system with an “Alert” tab displayed.

FIG. 3 is the system status page of a graphical user interface for a videoconferencing system showing a disconnected ISDN line.

FIG. 4 is a “help” page.

FIG. 5 shows an ISDN configuration page.

### DETAILED DESCRIPTION

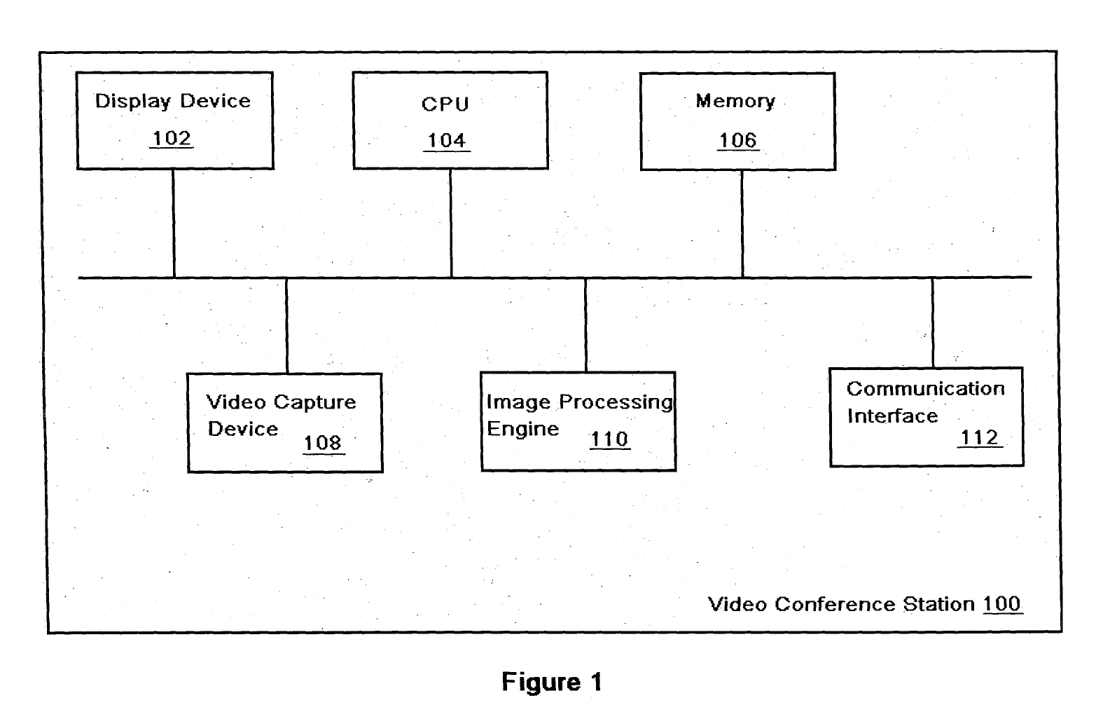

FIG. 1 is a block diagram of an exemplary video conference station 100. For simplicity, the video conference station 100 will be described as the local video conference station, although the remote video conference station may contain a similar configuration. In one embodiment, the video conference station 100 includes a display device 102, a CPU 104, a memory 106, at least one video capture device 108, an image processing engine 110, and a communication interface 112. Alternatively, other devices may be provided in the video conference station 100, or not all above-named devices provided. The at least one video capture device 108 may be implemented as a charge couple device (CCD) camera, a complementary metal oxide semiconductor (CMOS) camera, or any other type of image capture device. The at least one video capture device 108 captures images of a user, conference room, or other scenes, and sends the images to the image processing engine 110. Typically, the image processing engine 110 processes the video image into data packets before the communication interface 112 transmits the data packets to the remote video conference station. Conversely, the image processing engine 110 also transforms received data packets from the remote video conference station into a video signal for display on the display device 102.

Videoconferencing systems may include an interface for a packet-switched network such as the IP network and/or an interface for a switched network such as the public telephone system. Due to the bandwidth required, a videoconference connection over the telephone system frequently involves one or more ISDN lines. ISDN PRI and ISDN BRI lines differ in the number of channels involved. The network interface may comprise a gatekeeper, time server, Global Address Book (GAB) server, and/or a Global management (GM) server. A gatekeeper functions as a call manager or multi-point control unit. If an IP connection is lost, all of the foregoing may be lost.

The type of problem which may cause a system status alert may be a “local problem”—i.e., a problem which prevents the near-end system from communicating with, for example, the ISDN card or the gatekeeper. When such a problem is detected by the system, the ALERT tab or button may be displayed on the MAIN screen. User selection of the ALERT tab or button with, for example, the local system's remote control, causes-the local system to display the SYSTEM STATUS page on the system's display device which may be, for example, a television monitor.

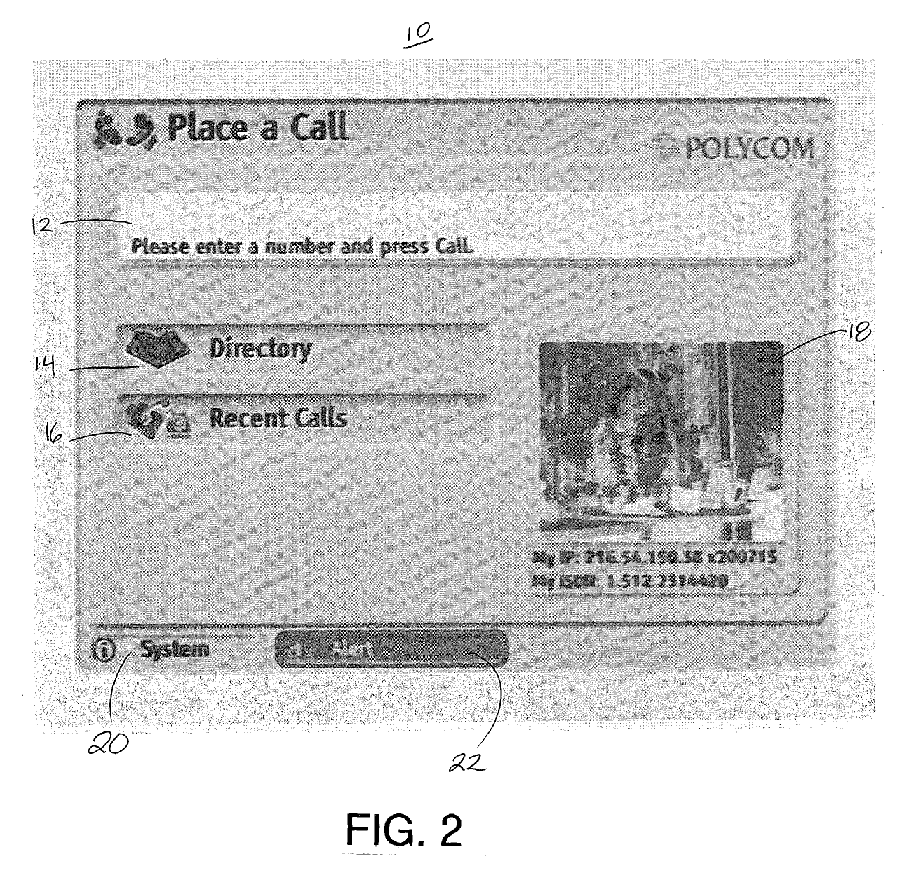

FIG. 2 depicts an example of the MAIN page 10 of one particular videoconferencing system. The page includes data entry area 12 which may be used, for example, to enter the telephone number of a remote videoconferencing unit to be called. “Tab” or virtual “button” (hereinafter “tab”) 14 may be selected by the user in order to display a telephone directory of remote videoconferencing systems. Tab 16 may be selected by the user to display a list of recently-made calls thereby winnowing the number of displayed phone numbers to those frequently used.

Selection of a tab may be made in any of the ways known in the art for selecting “hot areas” on a video display screen which acts an output device for a processor-based system. By way of example, appointing device such as a mouse or light pen may be used. Touch screens are another suitable input selection means, as are infrared or radio-based remote control devices.

MAIN screen 10 also includes video window 18 which may display the video signal from either the “near” or “far” end of the videoconference. In the particular example illustrated in FIG. 2, video window 18 contains a footer which displays the user's IP address and ISDN telephone line number.

Tab 20 is the SYSTEM tab which may be selected by the user to access certain administrative functions. In some embodiments, these administrative functions may be password protected.

Also shown in FIG. 2 is ALERT tab 22 which may appear on MAIN screen 10 when a problem in the embedded system is detected. As shown in the example of FIG. 2, ALERT tab 22 is highlighted (by, in the illustrated example, a change in the background color of the tab).

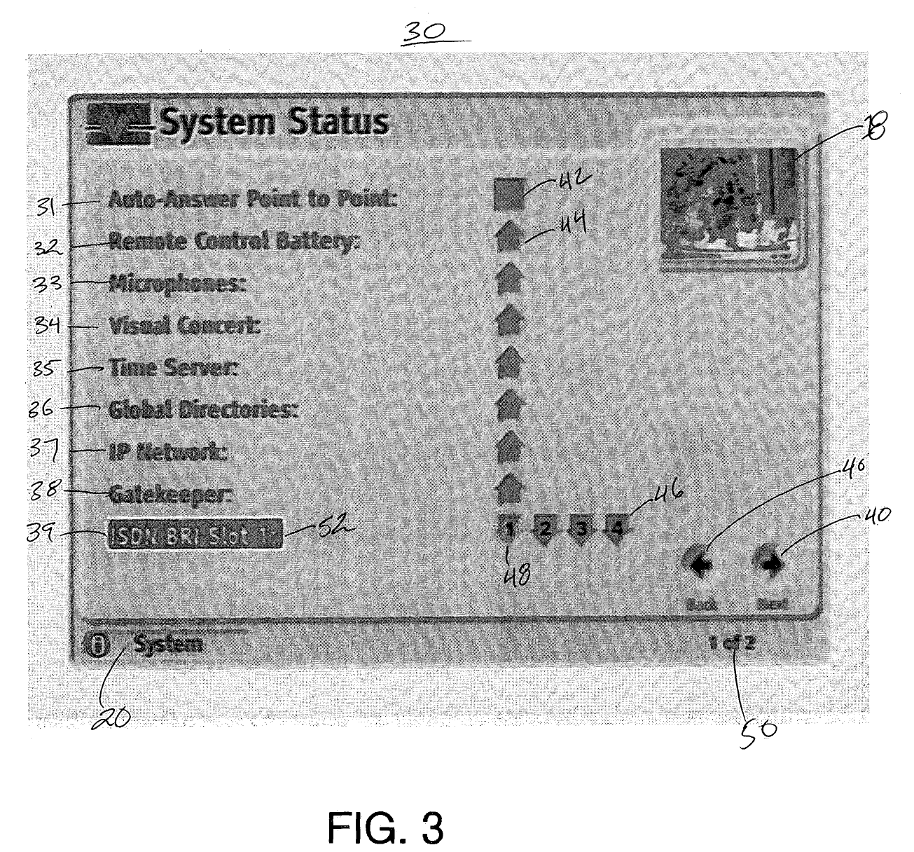

Selection of ALERT tab 22 by the user causes the display to change to a page which indicates the particular item(s) causing the fault condition. In the illustrated embodiment, the page used for this function is SYSTEM STATUS page 30. An example of a SYSTEM STATUS page is illustrated in FIG. 3.

Various subsystems may be shown on the SYSTEM STATUS page such as:

Auto-Answer Point to Point mode indicator 31; Remote Control Battery 32; Microphones 33; “Visual Concert” subsystem 34 which, in the particular embodiment illustrated, is used for notebook computer and projected displays; Timer Server 35; Global Directories availability 36; IP Network 37; Gatekeeper 38; and, ISDN BRI Slot 1. In some embodiments, the SYSTEM STATUS page may be available on the World Wide Web if the videoconference is using an IP connection. In this way, a remote diagnosis of a problem may be effected.

Associated with each displayed subsystem is a status indicator. For example Auto-Answer Point to Point mode 31 has associated indicator 42 which, in the illustrated example, is a rectangular status indicator which is indicative of a mode which does not affect the particular videoconference in progress—i.e., although not active or selected, the mode is not a system fault.

Subsystems 32 through 38, inclusive, have associated status indicators which are upwardly pointing arrows 44 in the illustrated example. An up arrow indicates a fully functional or “normal” state.

As seen in FIG. 3, ISDN BRI Slot 1 indicator 39 has four associated downwardly pointing arrows 46 numbered 1 through 4. Down arrow 1 has flag color 48 which may be used to indicate a problem or fault on ISDN line number 1—for example, the line may have been disconnected. The standard background color of lines 2 through 4 indicates that no particular problem has been detected, but the down arrow 46 indication may be used to show that these lines have not been selected for use in the particular videoconference being conducted.

Subsystem indicator 39 is shown with highlight 52 which may be used to indicate selection by the user. In some embodiments, initial highlighting of a subsystem having a fault condition may be performed by the system. The user may defer to the system's selection or may choose to select a different subsystem for further information.

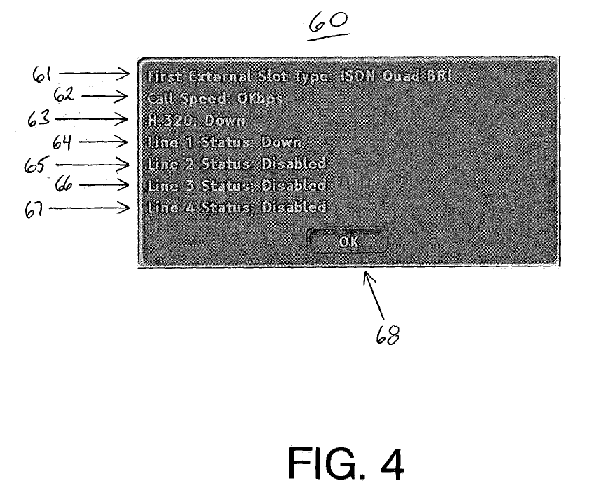

Activation of the selection may, in some embodiments, be used to access a “help” screen containing more detailed information on the particular subsystem selected. An example of a help screen for the ISDN BRI Slot 1 of a particular videoconferencing system is illustrated in FIG. 4 as screen 60.

More detailed information on the selected subsystem may be made available on such a “help” screen. In the illustrated example, the display includes: interface identifier 61; data transmission rate indicator 62; protocol status indicator 63; line 1 status indicator 64; line 2 status indicator 65; line 3 status indicator 66; and, line 4 status indicator 67.

In the example illustrated in FIG. 4, it can be seen that ISDN line 1 is down (63); lines 2,3, and 4 are disabled (64, 65, 66); no communications protocol is detected (63) (inasmuch as the only communications line is down); and the data rate is down to zero (62). The user may return to the previous screen by selecting the OK button 68.

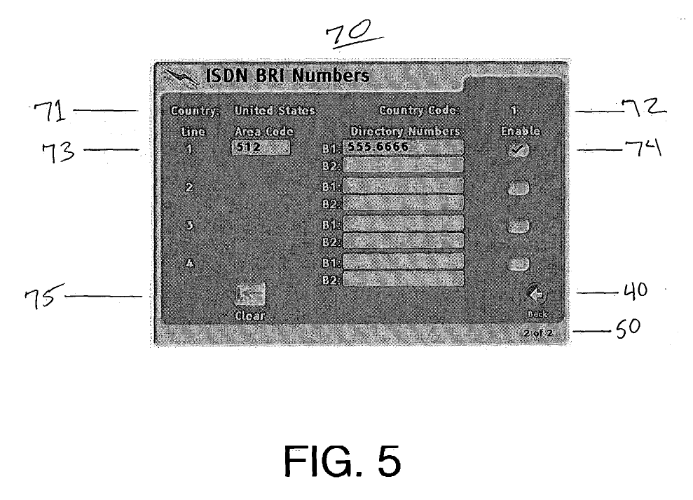

Referring now to FIG. 5, there is shown a representative example of ISDN line configuration screen 70. In some embodiments, this screen may be accessed by a CONFIG button or tab (not shown) on the “help” screen. The selected country is shown in country selection indicator 71 and the associated country code may be displayed in country code indicator field 72. Line 73 contains data entry fields for area codes and telephone numbers. Associated with each line is line selection indicator 74 which may be toggled by the user. In the embodiment shown in FIG. 5, an enabled line is indicated with a check mark in the rightmost column on the screen. For the convenience of the user, all data entry fields may be cleared by selecting “clear” button 75.

While the present invention has been described with respect to a limited number of embodiments, those skilled in the art will appreciate numerous modifications and variations therefrom. It is intended that the appended claims cover all such modifications and variations as fall within the true spirit and scope of this present invention.

1. A method for alerting the user of a videoconferencing system to a problem in the embedded system during a videoconference comprising:
displaying, in response to a detected malfunction, a selectable indicator on the graphical user interface of a videoconference terminal;
displaying, in response to user selection of the selectable indicator, a list of subsystems within the videoconference system; and,
associating with each displayed subsystem an icon indicative of the status of the subsystem.

2. A method as recited in claim 1 wherein an upwardly-pointing arrow is used as an icon indicative of the status of a functioning subsystem.

3. A method as recited in claim 1 wherein a downwardly-point arrow is used as an icon indicative of the status of a subsystem selected from the group consisting of malfunctioning subsystems, disconnected subsystems, non-responding subsystems, non-powered subsystems and unused subsystems.

4. A method as recited in claim 1 wherein a generally rectangular, geometric shape is used as an icon indicative of the status of a subsystem which is selected from the group consisting of unused subsystems, non-selected subsystems, non-essential subsystems, non-applicable subsystems, inactive subsystems and unnecessary subsystems.

5. A method for alerting the user of a videoconferencing system to a problem in the embedded system during a videoconference comprising:
displaying, in response to a detected malfunction, a selectable indicator on the graphical user interface of a videoconference terminal;
displaying, in response to user selection of the selectable indicator, a list of subsystems within the videoconference system;
associating with each displayed subsystem an icon indicative of the status of the subsystem; and,
displaying, in response to user selection of a displayed subsystem, additional information concerning the status of the selected subsystem.

6. A method as recited in claim 5 wherein the additional information concerning the status of the selected subsystem is textual information.

7. A method as recited in claim 5 wherein the additional information concerning the status of the selected subsystem is numeric information.

8. A method as recited in claim 5 wherein the additional information concerning the status of the selected subsystem is displayed in graphical form.

9. A processor-based videoconference terminal comprising a medium storing instructions for causing the processor to:
display, in response to a detected malfunction, a selectable indicator on a graphical user interface of the videoconference terminal;
display, in response to user selection of the selectable indicator, a list of subsystems within the videoconference system;
associate with each displayed subsystem an icon indicative of the status of the subsystem; and,
display, in response to user selection of a displayed subsystem, additional information concerning the status of the selected subsystem.

10. A method as recited in claim 1 further comprising
publishing on a website a list of subsystems within the videoconference system together with an icon indicative of the status of each subsystem.

11. A method as recited in claim 10 further comprising publishing a link to a web page containing additional information concerning a selected subsystem.

12. A method as recited in claim 11 wherein the link is a hypertext link.
